(19) United States
(12) Patent Application Publication
(10) Pub. No.: US 2010/0245044 A1
(43) Pub. Date: Sep. 30, 2010

(54) SECURITY STRUCTURE COMPRISING A THERMOCHROMIC ELEMENT AND A PHOTOCHROMIC ELEMENT

(75) Inventor: Philippe Dietemann, Saint-Martin-D'Heres (FR)

Correspondence Address: OLIFF & BERRIDGE, PLC, P.O. BOX 320850, ALEXANDRIA, VA, 22320-4850, US

(73) Assignee: Arjowiggins Security, Paris (FR)

(21) Appl. No.: 12/738,724

(22) PCT Filed: Oct. 21, 2008
(86) PCT No.: PCT/FR08/51899

§ 371 Date: May 12, 2010

(30) Foreign Application Priority Data
Oct. 26, 2007 (FR) 0758613

(51) Int. Cl. G06F 7/04; B32B 3/00

(52) U.S. Cl. 340/5.86; 428/29

(57) ABSTRACT

The present invention provides a security structure comprising: at least one photochromic layer presenting at least one photochromic zone including at least one photochromic element; and at least one thermochromic layer presenting at least one thermochromic zone including a thermochromic element, covering the photochromic zone at least in part.

The present invention relates to a security structure and to an article incorporating such a structure.

Patent application GB 2 272 861 discloses security documents presenting photochromic or thermochromic imprints that are capable of changing appearance as a function of temperature or of light in a process that is reversible.

Application WO 89/00319 also describes the use of photochromic elements for marking banknotes, and application EP 0 327 788 describes the use of photochromic ink for making security documents secure.

There exists a need to further improve the protection of articles such as security documents and/or documents of value against falsification.

The present invention seeks in particular to satisfy this need.

In one of its aspects, the invention provides a security structure comprising:
at least one photochromic layer presenting at least one photochromic zone including a photochromic element; and
at least one thermochromic layer presenting at least one thermochromic zone including a thermochromic element and covering the photochromic zone at least in part.

An article including such a security structure may be authenticated and/or identified by observing different appearances as a function of temperature and lighting, thereby reinforcing the protection of the article against falsification.

Furthermore, because of the presence of one or more photochromic and thermochromic elements, the invention makes it possible to provide a visible appearance that is variable and capable of creating novel optical effects that are attractive for an observer.

Finally, the thermochromic layer may also act as a protective layer for protecting the photochromic layer, and that may be found to be useful when using a photochromic element that ages poorly, in particular as a result of being exposed to variable lighting.

By way of example, the photochromic element may be selected from the dispersions of pigments or dyes sold by the suppliers A.I.C., Gem'innov, and Matsui.

The appearance of the photochromic element, e.g. its color or its transparency, varies as a function of the lighting to which it is subjected. The process whereby the appearance of the photochromic element varies may be reversible or non-reversible.

The photochromic element may be arranged in at least one pattern, e.g. an alphanumeric character, a drawing, a logo, or a symbol.

The photochromic layer may include a single photochromic zone or photochromic zones that are disjoint.

The thermochromic element may comprise a thermochromic pigment or dye, e.g. selected from the Live Colors range from Gem'innov, or from the powders or dispersions supplied by A.I.C. or Davis Liquid Crystals.

The appearance of the thermochromic element, its color or its transparency, varies as a function of the temperature to which the thermochromic element is subjected.

The process whereby the appearance of the thermochromic element varies may be reversible or non-reversible.

The thermochromic may be arranged in at least one pattern, e.g. one of those mentioned above, the thermochromic layer including a single thermochromic zone or thermochromic zones that are disjoint, for example.

The thermochromic element may take on a state that is sufficiently transparent to enable the underlying photochromic zone to be observed when said zone is in a state that makes it observable, and a state that is sufficiently opaque to mask the underlying photochromic zone and make it difficult or impossible to observe.

By way of example, the sufficiently transparent state is taken on at a temperature greater than ambient temperature, e.g. a temperature lying in the range 25° C. to 50° C., preferably in the range 25° C. to 40° C., e.g. 35° C., and more particularly a temperature that is close to the external temperature of a human being, in particular so as to enable the change of state to be obtained by finger contact.

In a variant of the invention, the change of state may be caused by heating, in particular by means of an incandescent lamp.

The superposition of the photochromic zone(s) by the thermochromic zone(s) may be exact or it may be partial, and the photochromic zone(s) may present patterns that are identical or different.

In a preferred embodiment of the invention, the photochromic zone(s) is/are completely covered by the thermochromic zone(s), in particular in such a manner as to protect the photochromic zone(s).

In an embodiment of the invention, the photochromic element presents an appearance that is colorless in the absence of light stimulation, e.g. a state that is substantially transparent, such that a pattern made from the photochromic element appears only after the thermochromic element has been made transparent under sufficient light stimulation.

The invention thus makes it possible to be different from a non-photochromic imprint already present under the thermochromic element and that continues to be visible.

A pattern made from the photochromic element need not become visible immediately as a function of lighting, even when the thermochromic element covering it is substantially transparent, as may occur with lighting that is dim or inactinic, for example.

The photochromic layer may advantageously include at least one non-photochromic zone having at least one non-photochromic imprint, metal-coating or metal-stripping, e.g. corresponding to an imprint using ink having no photochromic pigment or dye, e.g. an ink of black color that may be visible independently of lighting, e.g. when the thermochromic element becomes substantially transparent. This may enable an additional effect to be achieved or it may facilitate the perception of the change in the appearance of the photochromic layer.

The thermochromic layer may include at least one non-thermochromic zone having at least one non-thermochromic imprint, metal-coating or metal-stripping, e.g. corresponding to an imprint using an ink having no thermochromic pigment or dye, e.g. an ink of black color, capable of being visible independently of temperature. The presence of a non-thermochromic zone within the thermochromic layer may make it easier to observe an effect due to the presence of an additional layer covering the thermochromic layer and/or it may facilitate the observation of a variation in the appearance of the thermochromic layer.

The photochromic layer and/or the thermochromic layer may include metal-coating or metal-stripping.

In an embodiment of the invention, the structure includes an additional layer presenting at least one optically-variable zone, e.g. including a cholesteric liquid crystal and/or interference pigments, in particular suitable for being activated by the thermochromic colored background (e.g. pigments presenting a “colorswitch” effect on a black background, such as Colorstream pigments from Merck), giving an iridescent appearance, this optically-variable zone covering the thermochromic or photochromic zone, at least in part.

The term “cholesteric liquid crystal” designates a liquid crystal in a cholesteric phase, i.e. a liquid crystal in which the molecules are not precisely positioned, but present a privileged direction of orientation enabling the optical properties of the liquid crystal to be varied as a function of the radiation that is applied thereto, in particular enabling a goniochromatic appearance to be generated.

The presence of an additional layer including an optically-variable zone, e.g. having a cholesteric liquid crystal and/or interference pigments, may serve in particular to obtain an iridescent effect at the surface of the security structure as a function of temperature and lighting conditions, the optically-variable zone possibly being more or less visible as a function of the color of the underlying layers, e.g. the cholesteric liquid crystal may be observable on a background of dark color while being difficult to see on a pale background.

Thus, when the thermochromic element is of a dark or black color, the cholesteric liquid crystal also becomes observable. In contrast, when the thermochromic element is in a state in which it is substantially transparent, the cholesteric liquid crystal may become difficult or even impossible to observe with the naked eye.

The background behind the optically-variable zone may be constituted by elements that are both thermochromic and/or photochromic, or by imprints that are not thermochromic or not photochromic, or by metal-coating or metal-stripping, present within one or more of the above-mentioned layers or beneath them.

In an embodiment of the invention, the security structure includes at least one additional layer presenting at least one optically-variable zone, e.g. having a cholesteric liquid crystal and/or interference pigments, covering the photochromic zones at least in part. This additional zone is situated between the photochromic zone and the thermochromic zone, for example. The optically-variable zone(s) may extend in one or more patterns, superposed over at least one pattern of the thermochromic and/or photochromic layers, e.g. coinciding exactly therewith.

The optically-variable effect of said additional layer may be observable only when the thermochromic element is substantially transparent and the photochromic element is of a dark color, e.g. black.

The presence of an additional layer including an optically-variable zone makes it possible to obtain a very wide variety of appearances and further reinforces the security of the article.

The security structure provides reinforced security against falsification insofar as it is relatively easy to detect a defect in the positioning of the various layers. When the layers and the elements including them are exactly superposed, it is possible to observe the expected patterns or effects as a function of temperature and/or lighting. In contrast, when the layers and the elements they include are not exactly superposed and overlap onto adjacent zones, it may be impossible to observe the expected patterns of effects.

The additional layer(s), in particular any including one or more optically-variable zones, e.g. a cholesteric liquid crystal and/or interference pigments, may optionally include a non-printed zone (gap) and/or a printed zone that are not optically-variable, not photochromic, and not thermochromic, and/or a metal-coating, and/or a stripped metal coating.

The non-printed zone may be of arbitrary shape, in particular it may be rectangular, circular, oval, hexagonal, triangular, square, star-shaped, or with curved edges.

The photochromic and/or thermochromic layers may also include one or more non-printed zones.

At least one non-printed zone formed in the photochromic layer may be superposed with a non-printed zone formed in the thermochromic layer.

In an embodiment of the invention, the security structure includes at least one additional layer presenting a non-printed zone and/or at least one printed zone that is not photochromic and not thermochromic. This additional layer may be situated under the photochromic layer.

In another embodiment of the invention, the security structure includes a flexible medium that may be transparent or translucent, at least in part, and in particular in full. The medium may be made of plastics material, e.g. of polyester.

The photochromic and thermochromic layers may extend on the same side of the medium.

In order to further improve mechanical protection (varnish) or security protection (other), the security structure may include at least one element in the prior art and selected in particular from the following examples:
an electronic chip, in particular a radio frequency identity (RFID) chip;
a holographic or diffraction element;
a magnetic or crystal coating;
liquid crystals;
a varnish imprint;
a marker, in particular a biological, mineral, or synthetic marker;
a luminescent ink or substance; and
a piezochromic pigment.

The structure may be in various forms, e.g. in strip form, and it may for example constitute a security thread, or patch, for incorporating in a sheet or in a mass of paper pulp being formed into paper, or it may be formed in situ by printing and/or coating a medium such as a piece of paper or of plastics material, for example.

Thus, in an embodiment of the invention, the structure is arranged to be incorporated in or on the article.

Advantageously, the structure is incorporated in or on a medium, e.g. a substrate of the sheet or the article, so as to avoid impeding observation of the expected patterns or effects as produced by the elements of the various layers making up the structure.

In particular, incorporating the structure should not prevent the variation in the appearance of the photochromic elements of the photochromic layer as a function of the lighting to which they are subjected.

In a variant, the structure includes a support constituting a carrier strip arranged to be separated from at least one of the layers, in particular the thermochromic layer, after the structure has been applied on an article.

By way of example, the structure may consist in the following succession of layers: a layer comprising heat-sealing varnish applied on the medium; a layer comprising printing or metal-coating or stripped metal-coating; a photochromic layer; a thermochromic layer; optionally a layer including a protective varnish; a release layer; and a carrier strip.

Where appropriate, the structure may include at least one release layer between the medium and one of the layers, e.g. the thermochromic layer.

In another of its aspects, the invention also provides an article, e.g. a security document and/or a document of value, including a security structure as specified above.

The structure may be embedded at least in part in a layer of the article, for example it may comprise an alternation of zones embedded in the layer of the article and portions that are uncovered. In a variant, the structure may come flush with a face of the article, or it may be completely embedded therein.

In contact with the structure, the article may include at least one fiber layer, e.g. containing paper-making fibers, in particular cellulose fibers and/or fibers of a synthetic nature. In a variant, in contact with the structure, the article may include at least one non-fiber layer, e.g. a layer of plastics material.

In an embodiment of the invention, the security structure extends from a first edge of the article to a second edge that is opposite from the first.

The article may be designed to receive printing.

By way of example, the article may be a banknote, security paper, a passport sheet or cover, an access or identity card, a visa, a coupon, a document of value other than a banknote, e.g. a check or a credit card, a protective and/or authentication label, a traceability label, an optical disk, a ticket, a playing card, this list not being limiting.

In another of its aspects, the invention provides a method of authenticating and/or identifying an article including a structure as defined above, the method comprising the following steps:
observing a change in the appearance of the security structure of the article as a function of temperature and lighting; and
accepting the authenticity and/or identity of the article on the basis of at least one observed change in appearance.

The invention can be better understood on reading the following detailed description of non-limiting embodiments thereof, and on examining the accompanying drawings, in which:

FIG. 1 is a diagrammatic fragmentary section view of an example of an article made in accordance with the invention;

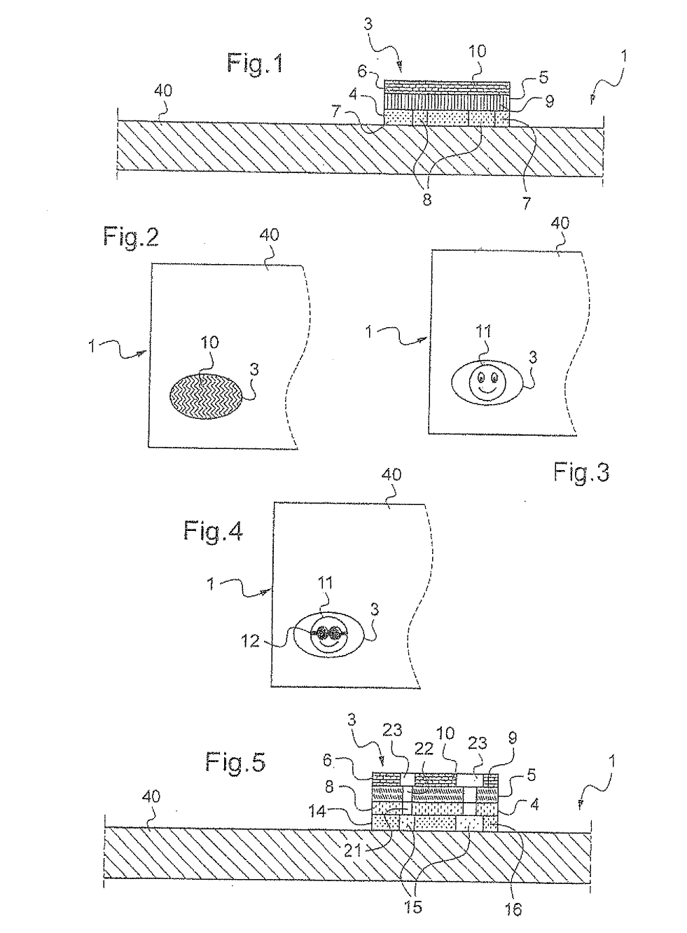

FIGS. 2 to 4 are diagrammatic and fragmentary views of different observable appearances of an article made in accordance with the invention, for different temperature and lighting conditions;

FIG. 5 is a diagrammatic and fragmentary section view of another example of an article made in accordance with the invention;

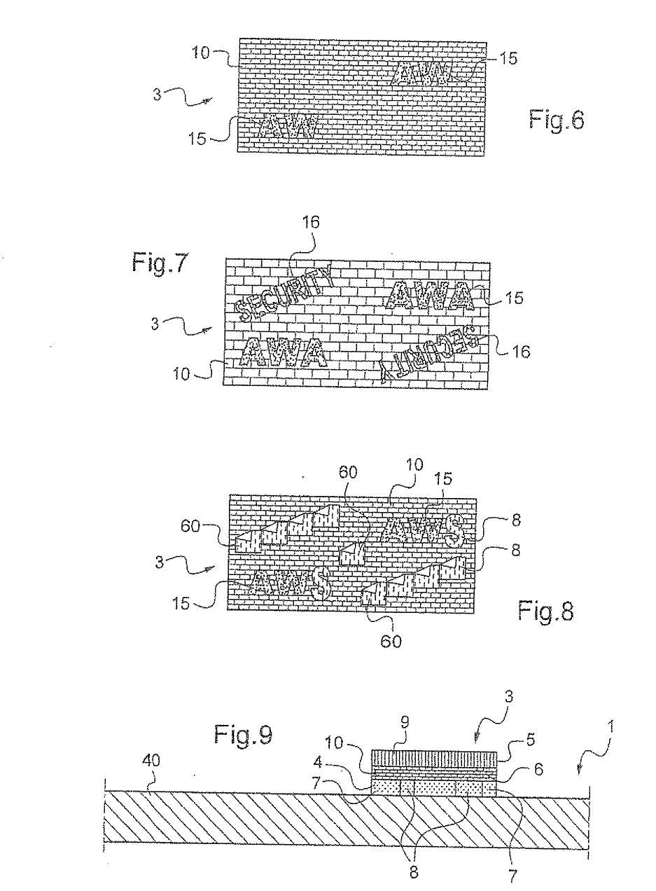

FIGS. 6 to 8 are diagrammatic and fragmentary views of different observable appearances of an article made in accordance with the invention, for different temperature and lighting conditions; and

FIG. 9 is a diagrammatic and fragmentary section view of another example of an article or structure made in accordance with the invention.

In the drawings, for reasons of clarity, the relative proportions of the different elements shown are not always complied with.

FIG. 1 shows a security article 1 or an article of value comprising a medium 40 carrying a security structure 3 in accordance with the invention.

In the example under consideration, the structure 3 comprises a photochromic first layer 4 including at least one photochromic 8 having at least one photochromic element, a thermochromic second layer 5 including at least one thermochromic zone 9 having at least one thermochromic element, and a covering third layer 6 including at least one optically-variable zone 10, e.g. a cholesteric liquid crystal and/or interference pigments.

In the example under consideration, the thermochromic zone 9 is continuous and covers the first layer 4 completely, and the optically-variable zone 10 is likewise continuous and covers the second layer 9 completely.

The photochromic zone(s) 8 of the first layer 4 extend for example in one or more predefined patterns and may be deposited on the medium 40 by printing.

In the example shown, the first layer 4 also includes at least one non-photochromic zone 7 corresponding to an imprint of a non-photochromic ink, e.g. ink of a black color.

The non-photochromic zone(s) 7 may be deposited in one or more predefined patterns.

The photochromic element presents optical properties that are sensitive to light radiation, e.g. visible, ultraviolet, or infrared radiation.

The opacity of the photochromic element may vary as a function of the light it receives.

By way of example, the photochromic element presents opacity that increases with illumination. For example, the photochromic element is substantially transparent in the absence of light, e.g. being colorless, and is capable of darkening with increasing light, e.g. taking on a black color.

The thermochromic element presents optical properties that change with temperature. By way of example, the opacity of the thermochromic element varies as a function of temperature. For example, the thermochromic element may pass reversibly from a substantially transparent state at a temperature above a threshold temperature Tₜₕ to a substantially opaque state at a temperature below Tₜₕ. By way of example, the temperature Tₜₕ may be greater than ambient temperature, e.g. lying in the range 25° C. to 40° C.

FIGS. 2 to 4 show the different appearances of the security structure depending on illumination and temperature.

In FIG. 2, the temperature and lighting conditions are such that the thermochromic zone 9 is not transparent, the security structure being at ambient temperature, for example.

The optically-variable zone 10 covering the thermochromic zone 9 is visible because of the underlying dark background defined by the thermochromic layer.

In FIG. 3, the temperature is higher than in FIG. 2 and the thermochromic zone 9 becomes transparent.

The layers 5 and 6 are sufficiently transparent for the pattern(s) 11 formed by the non-photochromic printed zone(s) 7 to be visible. The optically-variable zone 10 becomes difficult to see on a pale background.

In FIG. 4, the temperature is the same as in FIG. 3, but the incident light simulates the photochromic zone(s) 8 such that these zones 8 appear in the form of one or more patterns 12.

In the example of FIG. 1, the security structure 3 is formed in situ on the medium 40 or is transferred onto it after being transferred from a carrier strip, for example.

In a variant that is not shown, the security structure is carried by a carrier strip that is applied onto the medium 40, e.g. while it is being formed in a paper machine.

FIG. 5 shows a variant of the article 1.

In this example, the security structure 3 includes, under the photochromic layer 4, a printed layer 14 having first imprints 16, preferably of a dark color, e.g. black, and second imprints 15, e.g. of arbitrary color.

The printed layer 14 is covered by the photochromic layer 4 that includes the photochromic zones 8 and one or more non-printed zones 21. These zones may overlap the second printings 15.

The photochromic layer 4 is covered by the thermochromic layer 5 that includes the thermochromic zone(s) 9 and one or more non-printed zones 22.

The non-printed zones 21 and 22 may have substantially the same dimensions.

The covering layer 6 includes at least one optically-variable zone 10, e.g. including a cholesteric liquid crystal and/or interference pigments, and one or more non-printed zones 23.

These zones may have substantially the same dimensions as the second printings 15, e.g. the non-printed zone(s) 23 may be of dimensions that are greater than the non-printed zones 21 and 22.

By way of example, the non-printed zones 21, 22, and 23 may correspond to material missing from the corresponding layers.

FIGS. 6 to 8 show different steps in observing the security structure 3 of the article 1 of FIG. 5.

In FIG. 6, the temperature and lighting conditions are such that the thermochromic zones 9 are colored, thereby making the optically-variable zones 10 visible.

The non-printed zones 23, 22, and 21 present in the layers 4, 5, and 6 make it possible to see portions of the second imprints 15 corresponding to the portions seen through the non-printed zones 22.

In FIG. 7, the temperature is higher and the thermochromic zones 9 become transparent, with the photochromic zone(s) 8 being transparent likewise.

The optically-variable zone(s) 10 are no longer visible except in the zones containing the first printings 16. Thus, it is possible to observe another pattern formed by the first imprints 16 and also the portion of the second imprints 15 that correspond to the portion seen through the non-printed zones 23.

In FIG. 8, the temperature is the same as in FIG. 7, and the lighting conditions are such as to enable the photochromic zone(s) 8 to be activated. The photochromic zones 8 become opaque and serve to hide at least in part a portion of the first imprints 16, and they also cause other patterns 60 to appear.

In a variant, the layer 14 is a supporting film including metal-coated and metal-stripped zones, or imprints.

FIG. 9 shows another example of a structure 3 in accordance with the invention, this structure including an additional layer 6 presenting at least one optically-variable zone 10, e.g. including a cholesteric liquid crystal and/or interference pigments, and lying between the thermochromic and photochromic layers, e.g. completely covering the photochromic zone(s) 8.

At ambient temperature, the thermochromic layer is opaque and it masks the underlying layers.

On being heated, the optically-variable zone(s) may appear above the printed zones 7, if they are of dark color.

If the lighting is sufficient, the photochromic zone(s) are activated and they improve perception of the optically-variable zone(s) covering them, and/or may cause them to appear.

Naturally, the invention is not limited to the embodiments described above. In particular, the invention is not limited to photochromic elements that pass from an opaque state to a transparent state on temperature rising, nor is it limited to photochromic elements that pass from a transparent state to an opaque state in the presence of light.

The term “comprising a” should be understood as being synonymous with the term “comprising at least one” unless specified to the contrary.

1-16. (canceled)

17. A security structure comprising:
at least one photochromic layer presenting at least one photochromic zone including at least one photochromic element; and
at least one thermochromic layer presenting at least one thermochromic zone including a thermochromic element, covering the photochromic zone at least in part.

18. A security structure according to claim 17, the photochromic layer including at least one non-photochromic zone including at least non-photochromic imprint

19. A security structure according to claim 17, including at least one additional layer presenting at least one optically-variable zone.

20. A structure according to claim 19, the additional layer covering the thermochromic layer, at least in part.

21. A security structure according to claim 20, the optically-variable zone covering the thermochromic zone, at least in part.

22. A security structure according to claim 17, including at least one additional layer presenting at least one optically-variable zone covering the photochromic layer, at least in part.

23. A security structure according to claim 22, the optically-variable zone covering the photochromic zone, at least in part.

24. A security structure according to claim 20, the optically-variable zone including a cholesteric liquid crystal and/or interference pigments.

25. A security structure according to claim 22, the additional layer being situated between the photochromic layer and the thermochromic layer.

26. A security structure according to claim 19, the additional layer including a non-printed zone.

27. A security structure according to claim 17, including an additional layer presenting at least one non-printed zone and/or at least one printed zone that is/are not photochromic and not thermochromic.

28. A security structure according to claim 27, the additional layer being situated under the photochromic layer.

29. A structure according to claim 28, the security structure including a first additional layer under the photochromic layer and including an imprint defining at least one pattern of dark color, and a second additional layer presenting one or more optically-variable zones situated above the thermochromic layer, and presenting one or more non-printed zones superposed over one or more non-printed zones of the photochromic and thermochromic layers.

30. An article including a security structure as defined in claim 17.

31. An article according to claim 30, selected from: a banknote, security paper, a passport sheet or cover, a visa, a coupon, a document of value, a check, a credit card, a protective and/or authentication label, a traceability label, an optical disk, a ticket, a playing card.

32. A method of authenticating and/or identifying an article including a structure as defined in claim 17, the method comprising:
observing a change in the appearance of the security structure as a function of temperature and lighting; and
accepting the authenticity and/or identity of the article on the basis of at least one observed change in appearance.
